(19) United States
(12) Patent Application Publication
(10) Pub. No.: US 2004/0268032 A1
(43) Pub. Date: Dec. 30, 2004

(54) Modular content addressable memory

(76) Inventors: Badarinath N. Kommandur, Hillsboro, OR (US); Wilfred Gomes, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/609,714

(22) Filed: Jun. 30, 2003

(51) Int. Cl. G06F 13/00

(52) U.S. Cl. 711/108

(57) ABSTRACT

According to one embodiment a content addressable memory (CAM) is disclosed. The CAM includes a memory array including a plurality of storage elements, a first read port, and a first set of bit compare components associated with the first read port and each of the plurality storage elements to compare bit data. Each of the first set of bit compare components are positioned separate from an associated storage element.

### FIELD OF THE INVENTION

The present invention relates to computer systems; more particularly, the present invention relates to content addressable memory devices.

### BACKGROUND

Increasingly, microprocessors are implementing additional cache structures to improve performance. Such cache structures are beginning to include an increasing number of array structures that have embedded CAM (Content Addressable Memory) elements. The basic function of a CAM involves comparing an incoming stream of data bits (key) with stored match bits in a memory array. If a match occurs, the resulting location pointer is used to read out the data associated with the pointer.

Typically, CAMs may have more than one incoming key. Thus, the match operation is to be done in parallel, with the resulting match pointers being used to index a multi-ported data array simultaneously for maximum throughput. However, implementing additional ports results in the addition of logic within a particular memory cell to accommodate each additional port. For instance, the addition of each port results in the memory pitch increasing N², where N is the number of ports. This results in significant increase in delay of all operations and increased power due to increased dimensions of critical nets for wordlines, bitlines and match nodes.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a computer system;

FIG. 2 illustrates an exemplary content addressable memory (CAM);

FIG. 3 illustrates an exemplary CAM array;

FIG. 4 illustrates an exemplary CAM memory cell;

FIG. 5 illustrates one embodiment of a CAM;

FIG. 6 illustrates another embodiment of a CAM; and

FIG. 7 illustrates yet another embodiment of a CAM.

### DETAILED DESCRIPTION

A content addressable memory (CAM) is described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

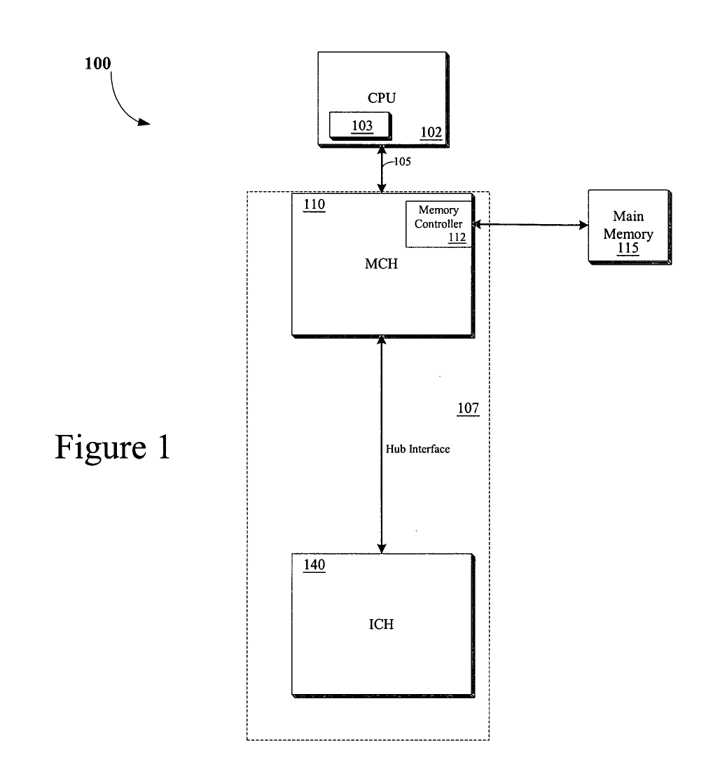

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions and code represented by data signals that may be executed by CPU 102 or any other device included in system 100.

In one embodiment, main system memory 115 includes dynamic random access memory (DRAM); however, main system memory 115 may be implemented using other memory types. Additional devices may also be coupled to bus 105, such as multiple CPUs and/or multiple system memories.

In one embodiment, MCH 110 is coupled to an input/output control hub (ICH) 140 via a hub interface. ICH 140 provides an interface to input/output (I/O) devices within computer system 100. For instance, ICH 140 may be coupled to a Peripheral Component Interconnect bus adhering to a Specification Revision 2.1 bus developed by the PCI Special Interest Group of Portland, Oreg.

According to one embodiment, a cache memory 103 resides within processor 102 and stores data signals that are also stored in memory 115. Cache 103 speeds up memory accesses by processor 103 by taking advantage of its locality of access. In another embodiment, cache 103 resides external to processor 103.

In one embodiment, cache 103 is a CAM. A CAM is a memory device that accelerates any application requiring fast searches by simultaneously comparing desired information against an entire list of pre-stored entries. Thus, resulting in an order-of-magnitude reduction in the search time.

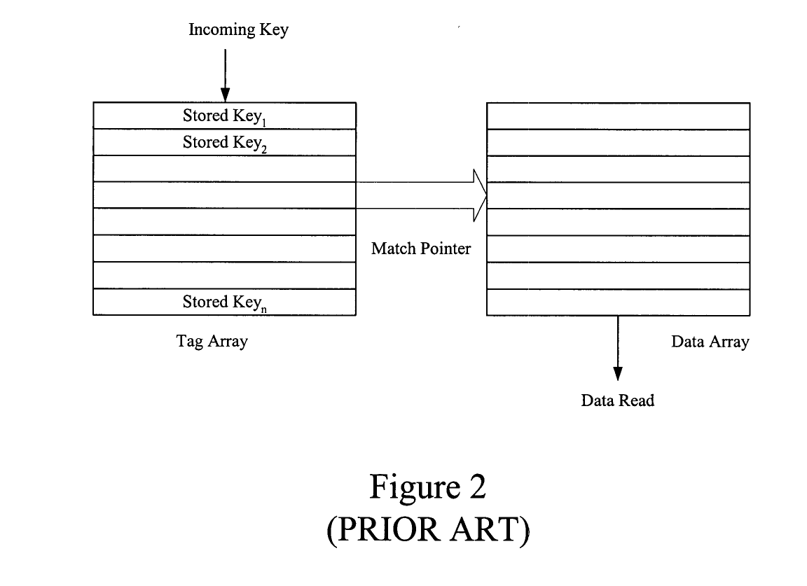

FIG. 2 illustrates an exemplary CAM. The CAM features a tag array that stores information as data keys. Once the information is stored in a memory location, it is found by comparing an incoming stream of data (or key) with every bit in memory. If there is a match for every bit in a location with every corresponding bit, a match pointer is asserted and is used to read data from a data array that is associated with the pointer.

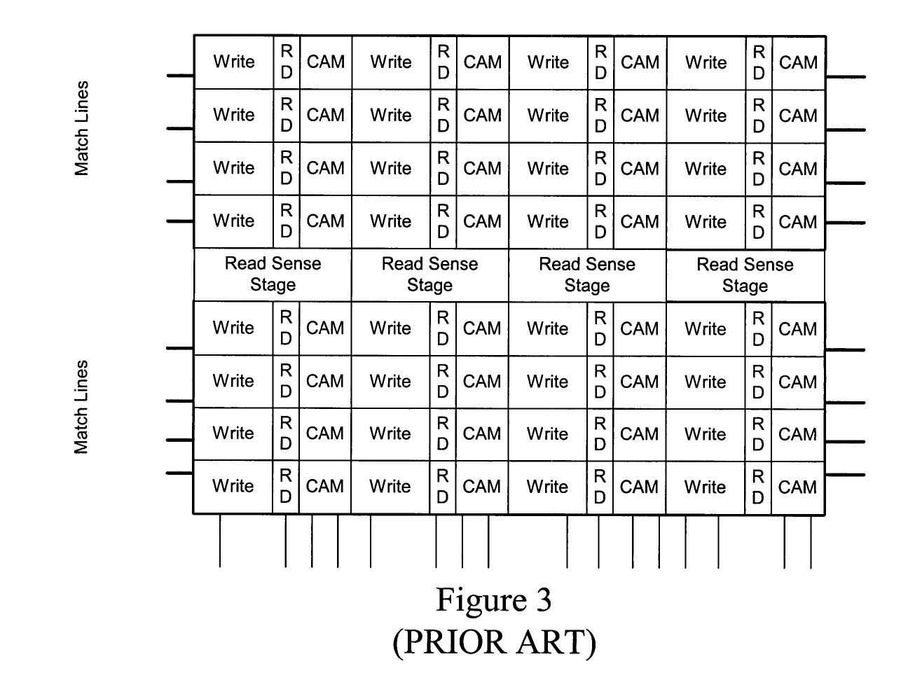

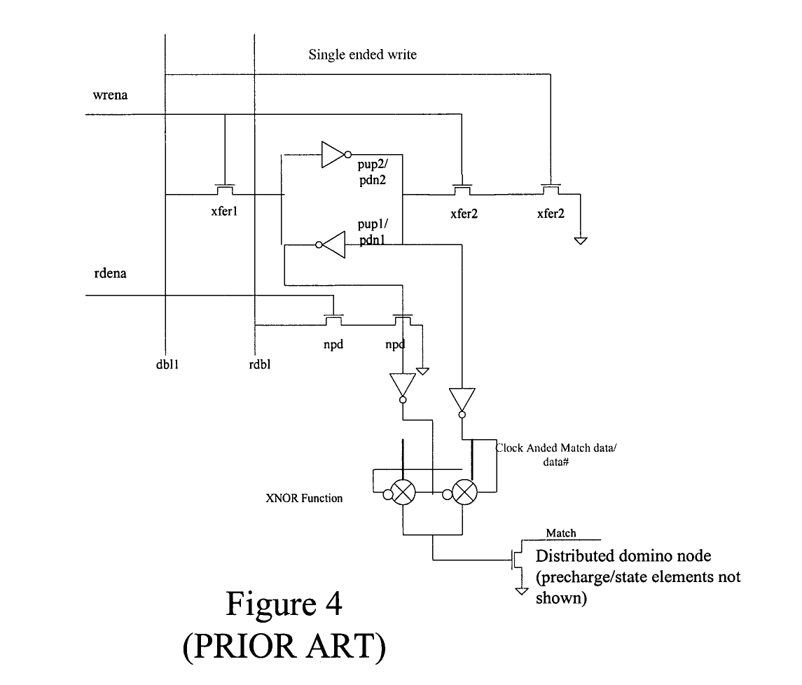

FIG. 3 illustrates an exemplary CAM array. The array includes 4×4 memory cells. Each memory cell includes read and write components as well as a core memory cell. FIG. 4 illustrates an exemplary memory cell. The logic illustrated in the memory cell shown in FIG. 4, implements the function shown for a cell in FIG. 3 (e.g., read, write and CAM). In addition, the memory cell includes exclusive-nor (XNOR) logic that is used to detect a match. If a match is detected, the data is distributed to a domino node.

Typically, CAMs have more than one incoming key. Thus, the match operation may be required to be done in parallel, with the resulting match pointers being used to index a multi-ported data array simultaneously for maximum throughput. With the addition of more CAM ports, the XNOR and domino comparator logic needs to be replicated on a per entry basis. Thus, each memory cell must include additional XNOR logic for each additional port implemented at the CAM.

The pitch of the CAM memory cell will be determined by the number of metal tracks in both X and Y direction. As a result, for a metal limited memory cell, the bit pitch of the CAM cell will increase by a factor of N² with the addition of N ports. This will result in significant delay penalty for all three operations, (e.g., reads out of the CAM array, writes into the CAM array and match operation).

Moreover, since the length of the read, write and match lines will increase with a N² factor with the addition of N ports, the power consumption will also increase proportional to the increase in the wiring capacitance. The switching device capacitance will also increase since the devices will need to be upsized to drive the increased wire load for same delay through each stage.

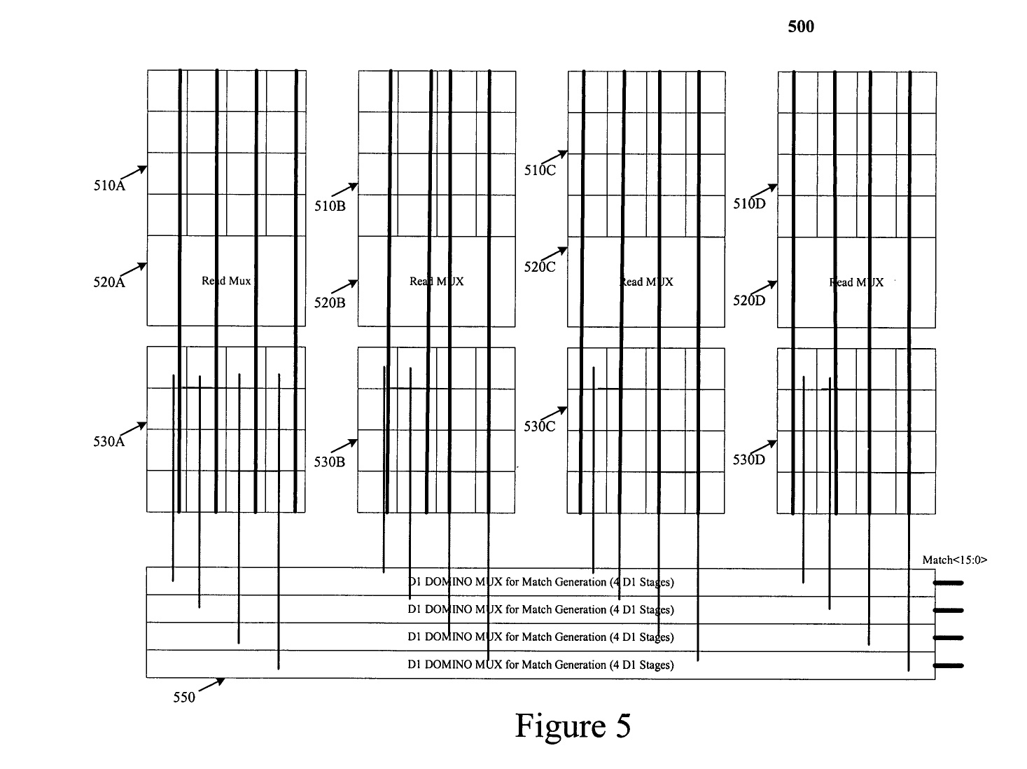

According to one embodiment, the read, XNOR function and the domino match functions are separated from the core storage element. FIG. 5 illustrates one embodiment of a CAM array 500. CAM array 500 includes memory blocks 510 (e.g., 510A-510D), read multiplexers (Muxes) 520 (e.g., 520A-520D), exclusive-or (XOR) components 530 (e.g., 530A-530D) and domino comparators 550.

In one embodiment, each memory block 510 includes 16 storage cells. The memory blocks 510 correspond to entries for a particular bit. For example, block 510A corresponds to bit 0 for storage entries 0-15. Similarly, block 510B corresponds to bit 1 for storage entries 0-15, and so on for blocks 510C and 510D.

According to one embodiment, storage elements in the bitline direction of each block 510 are folded to form a 4×4 grid for the memory blocks. This is accomplished by folding the 4×4 memory grid corresponding to 16 entries for each of the M bits in the bitline direction. Although described as a 4×4 grid, one of ordinary skill in the art will appreciate that memory blocks 510 may be implemented with any n×m grid, where n=2, 4, 8, 16, etc., and m=2, 4, 8, 16, etc.

Read MUXes 520 are used to conduct memory reads of a particular memory block 510. For instance, Mux 520A is used to read data from memory block 510A. In one embodiment, the read operation is accomplished through a folding of the 16 storage element entries of a memory block 510 corresponding to each bit.

XOR components 530 compare the contents of a corresponding memory block 510 to data received as an incoming key. As described above, the XOR function for each bit of CAM array 500 is removed from the storage element. In one embodiment, each XOR component 530 is clustered into a 4×4 grid to correspond to a particular 16-entry memory block 510.

In a further embodiment, an internal state element node is routed to a local bit line input and extended as an input to each 4×4 input of an XOR block 530. The state element node is then compared to the incoming key. The output of each XOR component 530 is routed to corresponding inputs of domino comparator 550, which is placed below the XOR block 530.

Domino comparators 550 use a not-or (NOR) tree to compare the stored word data with the incoming data word. As a result, domino comparator transmits a 16-bit match output. In one embodiment, the domino element for the comparator is implemented in a single hierarchy spanning M bits of match elements. However, in other embodiments, the M bits of match operation can be implemented in a pitch equal to (4*M/2)=2M memory cell pitches in the wordline direction by folding the match function.

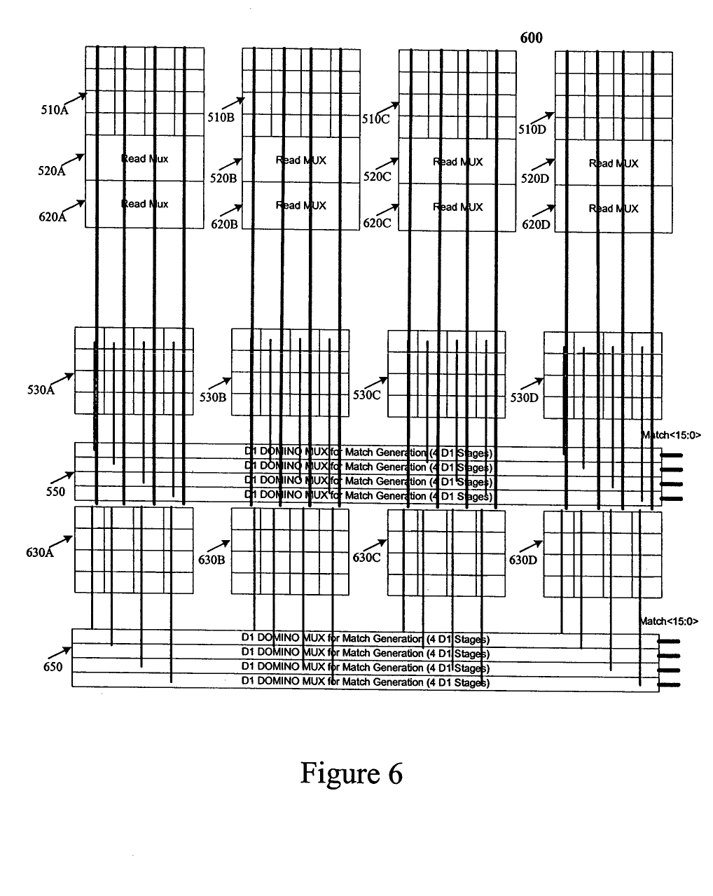

FIG. 6 illustrates one embodiment of a CAM array 600. Cam array 600 includes two ports (ports 0 and 1). Therefore, CAM array 600 includes memory blocks 610 (e.g., 610A-610D), read Muxes 620 (e.g., 620A-620D), XOR components 630 (e.g., 630A-630D) and domino comparators 650, in addition to memory blocks 510, read Muxes 520 XOR components 530 and domino comparators 550.

The operation of CAM array 600 is the same as CAM array 600, except for the addition of logic components. Since the write, read and CAM portions of the CAM 600 register file are separated and implemented as stand alone components, the layout can be extended by stacking additional read port tiles, XOR and domino match tiles for each additional port.

Since the addition of read ports does not impact core memory cell or the CAM port, the same building blocks for writes, reads and CAM ports can be used to build any arbitrary combination of read/write/CAM ports for a given register file. Note that CAM arrays 500 and 600 can be replicated to generate a larger array with multiple entries and match operation performed across additional bits, though FIGS. 5 and 6 illustrate 4 bits×16 entries.

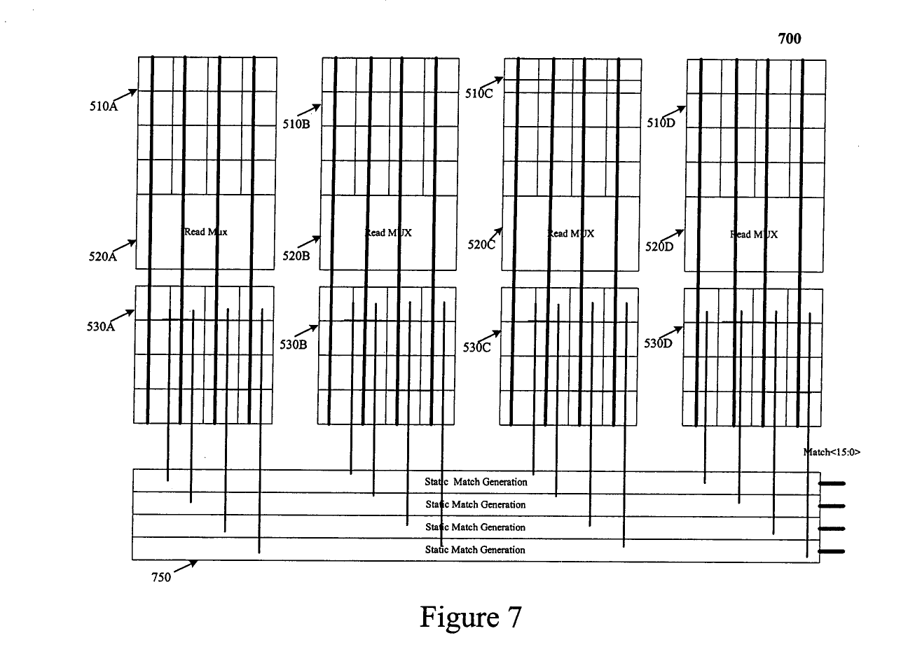

FIG. 7 illustrates one embodiment of a CAM array 700. CAM array 700 includes a static match component 750 rather than domino match logic. In one embodiment, static match component 750 implements a match operation using a static AND tree, rather than the NOR function used by domino logic. Thus, in cases where the CAM operation is not latency critical, power can be conserved by using a static implementation in the multi-level AND tree.

The CAM array structures described above enables building of arbitrary variations of RF arrays with embedded CAM functions with few pre-characterized library cells leading to higher design productivity. In addition, the above-described architectures eliminate the need for unique memory cells necessitated by adding combinations of read, write and cam ports in previous CAM arrays. Consequently, higher layout density is achieved.

Further, lower power is consumed due to the denser layout. Therefore, minimization of wiring capacitance may occur, leading to smaller device sizes, which in turn result in reduced leakage and dynamic power. Also, the higher layout density results in faster frequency of operation due.

Although, the above-described CAMs have been discussed with reference to cache applications, one of ordinary skill in the art will appreciate that other applications may be implemented. For example, CAMs 500, 600 and 700 may be used for searches of a database, list, or pattern, such as in database machines, image or voice recognition, or computer and communication networks.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A content addressable memory (CAM) comprising:
a memory array including a plurality of storage elements;
a first read port; and
a first set of bit compare components associated with the first read port and each of the plurality of storage elements to compare bit data, each of the first set of bit compare components positioned separate from an associated storage element.

2. The CAM of claim 1 further comprising a first word compare component associated with the first set of bit compare components to compare stored word data with a received data word.

3. The CAM of claim 2 wherein the first word compare component comprises domino match logic to implement the compare operation with a Not Or function.

4. The CAM of claim 2 wherein the first word compare component comprises static match logic to implement the compare operation with an And function.

5. The CAM of claim 1 wherein the plurality of storage elements are divided into two or more memory blocks and wherein each memory block corresponds to a storage bit for a plurality of data entries.

6. The CAM of claim 5 wherein each memory block includes 16 storage elements.

7. The CAM of claim 6 wherein the storage elements in each memory block are folded to form a 4×4 grid by folding the 4×4 memory grid corresponding to 16 entries for each of the bits in the bitline direction.

8. The CAM of claim 7 wherein the first read port comprises a multiplexer associated with each of the two or more memory blocks to conduct memory reads of an associated memory block.

9. The CAM of claim 8 wherein the read operation is accomplished through a folding of the 16 storage element entries of an associated memory block corresponding to each bit.

10. The CAM of claim 8 wherein the first set of bit compare components comprise Exclusive-Or logic associated with each of the two or more memory blocks.

11. The CAM of claim 8 wherein the first set of bit compare components comprise Exclusive-Not-Or logic associated with each of the two or more memory blocks.

12. The CAM of claim 10 wherein the first set of bit compare components are folded into a 4×4 grid to correspond to an associate memory block.

13. The CAM of claim 12 wherein the output of the first set of bit compare components is outputted to corresponding inputs of the first word compare component.

14. The CAM of claim 2 further comprising:
a second read port; and
a second set of bit compare components associated with the second read port and each of the plurality of storage elements to compare bit data, each of the second set of bit compare components positioned separate from an associated storage element.

15. The CAM of claim 14 wherein the second set of bit compare components are positioned separate from the first set of bit compare components.

16. The CAM of claim 14 further comprising a second word compare component associated with the second set of bit compare components to compare stored word data with a second received data word.

17. A computer system comprising:
a central processing unit (CPU); and
a cache memory accessible to the CPU, the cache memory including:
a memory array including a plurality of storage elements;
a first read port; and
a first set of bit compare components associated with the first read port and each of the plurality of storage elements to compare bit data, each of the first set of bit compare components positioned separate from an associated storage element.

18. The computer system of claim 17 wherein the cache memory further comprises a first word compare component associated with the first set of bit compare components to compare stored word data with a received data word.

19. The computer system of claim 17 wherein the plurality of storage elements are divided into two or more memory blocks and wherein each memory block corresponds to a storage bit for a plurality of data entries.

20. The computer system of claim 18 further comprising:
a second read port; and
a second set of bit compare components associated with the second read port and each of the plurality of storage elements to compare bit data, each of the second set of bit compare components positioned separate from an associated storage element.

21. The computer system of claim 20 wherein the second set of bit compare components are positioned separate from the first set of bit compare components.

22. The computer system of claim 20 further comprising a second word compare component associated with the second set of bit compare components to compare stored word data with a second received data word.

23. A memory device comprising:
a memory array including a plurality of storage elements;
a first read port;
a first set of bit compare components associated with the first read port and each of the plurality of storage elements,
a second read port; and
a second set of bit compare components associated with the second read port and each of the plurality storage elements;
wherein each of the first set and second set of bit compare components positioned separate from an associated storage element.

24. The memory device of claim 23 further comprising:
a first word compare component associated with the first set of bit compare components to compare stored word data with a data word received at the first port; and
a second word compare component associated with the second set of bit compare components to compare stored word data with a data word received at the second port.

25. The memory device of claim 24 wherein the first and second word compare components comprise domino match logic to implement the compare operation with a Not Or function.

26. The memory device of claim 24 wherein the first and second word compare components comprise static match logic to implement the compare operation with an And function.

27. The memory device of claim 23 wherein the plurality of storage elements are divided into two or more memory blocks and wherein each memory block corresponds to a storage bit for a plurality of data entries.

28. The memory device of claim 27 wherein each memory block includes 16 storage elements.

29. The memory device of claim 28 wherein the storage elements in each memory block are folded to form a 4×4 grid by folding the 4×4 memory grid corresponding to 16 entries for each of the bits in the bitline direction.

30. The memory device of claim 29 wherein the read operation is accomplished through a folding of the 16 storage element entries of an associated memory block corresponding to each bit.
